(19) United States
(12) Patent Application Publication
(10) Pub. No.: US 2026/0187904 A1
(43) Pub. Date: Jul. 2, 2026

(54) METHOD AND DEVICE FOR DETERMINING COLOR OF IMAGE BASED ON RADIANCE INFORMATION OF VOXEL

(71) Applicant: SAMSUNG ELECTRONICS CO.,LTD., Suwon-si (KR)

(72) Inventors: Hyeonseung YU, Suwon-si (KR); Nahyup KANG, Suwon-si (KR)

(73) Assignee: SAMSUNG ELECTRONICS CO.,LTD., Suwon-si (KR)

(21) Appl. No.: 19/267,131

(22) Filed: Jul. 11, 2025

(30) Foreign Application Priority Data
Dec. 26, 2024 (KR) 10-2024-0196993
Feb. 11, 2025 (KR) 10-2025-0017617

(51) Int. Cl. G06T 15/06; G06T 7/90; G06T 15/08

(52) U.S. Cl. CPC G06T 15/06; G06T 7/90; G06T 15/08; G06T 2207/10024

(57) ABSTRACT

A method for determining a color of an image is provided. The method includes determine a target point by using a virtual ray projected toward a target pixel on an image plane among a plurality of pixels of a two-dimensional (2D) image from a viewpoint, based on obtaining the viewpoint in a three-dimensional (3D) space and information on the image plane; determine a target voxel including the target point among a plurality of voxels of the 3D space; determine an incident direction in which the virtual ray is incident on the target point; obtain radiance information on each basis of the target voxel with respect to a plurality of bases; and determine a radiance of the target point corresponding to the incident direction by using the incident direction and the radiance information on each basis of the target voxel.

### CROSS-REFERENCE TO RELATED APPLICATION(S)

This application claims priority from Korean Patent Application No. 10-2024-0196993, filed on Dec. 26, 2024, and Korean Patent Application No. 10-2025-0017617, filed on Feb. 11, 2025, in the Korean Intellectual Property Office, the entire disclosures of which are incorporated herein by reference for all purposes.

### BACKGROUND

### 1. Field

Methods and apparatuses consistent with embodiments of the present disclosure relate to determining the color of an image based on radiance information of a voxel.

### 2. Description of the Related Art

Three-dimensional (3D) rendering is a field of computer graphics for rendering a 3D scene into a two-dimensional (2D) image. 3D rendering may be used in various application fields, such as 3D games, virtual reality, animation, or movies. Neural rendering may include a method of converting a 3D scene into a 2D output image by using a neural network. A neural network may be trained based on deep learning and may perform inference for a desired purpose by mapping input data and output data that are in a nonlinear relationship to each other. The trained ability to generate such mapping may be referred to as a learning ability of the neural network. A neural network may train a method of observing an actual scene and modeling and rendering that scene.

The above description is information the inventor(s) acquired during the course of conceiving the present disclosure, or already possessed at the time, and is not necessarily art publicly known before the present application was filed.

### SUMMARY

One or more embodiments may address at least the above problems and/or disadvantages and other disadvantages not described above. Also, the embodiments are not required to overcome the disadvantages described above, and an embodiment may not overcome any of the problems described above.

According to an aspect of an embodiment, there is provided a method performed by an electronic device including determining a target point by using a virtual ray that is projected toward a target pixel on an image plane among a plurality of pixels of a two-dimensional (2D) image from a viewpoint, based on obtaining the viewpoint in a two-dimensional (3D) space and information on the image plane; determining a target voxel including the target point among a plurality of voxels of the 3D space; determining an incident direction in which the virtual ray is incident on the target point, obtaining radiance information on each basis of the target voxel with respect to a plurality of bases; and determining a radiance of the target point corresponding to the incident direction by using the incident direction and the radiance information on each basis of the target voxel.

The method may further include determining the color of the target pixel based on the radiance of the target point and obtaining the 2D image corresponding to a scene of the 3D space, which is a result of projecting the virtual ray toward the image plane from the viewpoint, by determining the color of each of the plurality of pixels of the 2D image.

The obtaining the radiance information on each basis of the target voxel may include obtaining, as radiance information of each vertex of the target voxel, radiance feature coefficients indicating radiances of a vertex according to the plurality of bases.

The determining the target point may include determining a point where a scattering of the virtual ray occurs as the target point.

The determining the radiance of the target point may include determining a radiance of a vertex corresponding to the incident direction by using the incident direction and radiance information on each basis of the vertex with respect to a plurality of vertices of the target voxel; and based on a distance between a position of the target point in the target voxel and each vertex of the target voxel, obtaining a result of interpolating radiances of the plurality of vertices as the radiance of the target point.

The determining the target point may include determining a first target point based on a scattering of the virtual ray at the first target point in the 3D space; and determining a second target point based on a scattering at the second target point in the 3D space after the virtual ray scatters at the first target point.

The determining the target voxel may include determining a first target voxel including the first target point and determining a second target voxel including the second target point.

The determining the target voxel may further include determining whether to continue tracing a path of the virtual ray based on at least one parameter on the scattering at the first target point, the determining of the second target point may include determining the second target point based on continuing of the tracing of the path of the virtual ray, and the determining of the second target voxel may include determining the second target voxel comprising the second target point based on the continuing of the tracing of the path of the virtual ray.

The determining the radiance of the target point may include determining a first radiance of the first target point corresponding to a direction from the target pixel to the first target point, based on radiance information on each basis of the first target voxel; determining a second radiance of the second target point corresponding to a direction from the first target point to the second target point, based on radiance information on each basis of the second target voxel; and obtaining an adjusted second radiance of the second target point, which indicates radiance of a ray reaching the target pixel from the second target point through the first target point, based on the second radiance of the second target point and a bidirectional scattering distribution function (BSDF) of the first target point; and the method may further include determining a color of the target pixel based on the first radiance of the first target point and the adjusted second radiance of the second target point.

The determining of the incident direction may include determining a first incident direction toward the first target point from the viewpoint and determining a second incident direction toward the second target point from the first target point, the determining of the first radiance of the first target point may include determining the first radiance of the first target point corresponding to the first incident direction, based on the radiance information on each basis of the first target voxel, the first incident direction, and the first target point, the determining of the second radiance of the second target point may include determining the second radiance of the second target point corresponding to the second incident direction by using the radiance information on each basis of the second target voxel, the second incident direction, and the second target point, and the obtaining of the adjusted second radiance may include adjusting the second radiance by applying a weight based on the BSDF of the first target point to the second radiance of the second target point corresponding to the second incident direction.

The method may further include obtaining a training pixel among the plurality of pixels of the 2D image, based on the obtaining of the viewpoint and the information on the image plane, determining one or more training voxels including at least one point where a training virtual ray projected toward the training pixel from the viewpoint scatters in the 3D space, determining a temporary color of the training pixel based on radiance information on each basis of the one or more training voxels, obtaining a ground-truth color of the training pixel, and determining a variance in the radiance information on each basis of the one or more training voxels based on a difference between the temporary color of the training pixel and the ground-truth color of the training pixel.

The determining of the one or more training voxels may include, based on determining a training voxel, adding the training pixel to a training data set of vertices of the training voxel. The determining of the variance in the radiance information on each basis of the one or more training voxels may include determining a variance in radiance information on each basis of a vertex based on a training data set of the vertex with respect to each vertex. The method may further include, with respect to each vertex, based on the determined variance in the radiance information on each basis of the vertex, changing the radiance information on each basis of the vertex.

The adding the training pixel to the training data set of vertices of the training voxel may include, based on determining the training voxel, comparing a number of other training pixels included in the training data set of a vertex of the training voxel with a threshold number; based on the number of other training pixels included in the training data set of the vertex of the training voxel being greater than or equal to the threshold number, skipping the adding of the training pixel to the training data set of vertices; and based on the number of other training pixels included in the training data set of the vertex of the training voxel being less than the threshold number, adding the training pixel to the training data set of the vertex.

The method may further include dividing the 3D space into a plurality of super-voxels having a greater size than a voxel size; determining one or more training super-voxels including at least one point where the training virtual ray scatters, based on the temporary color of the training pixel and the ground-truth color of the training pixel; changing radiance information on each basis of the one or more training super-voxels; and based on the changed radiance information on each basis of the one or more training super-voxels, changing radiance information on each basis of at least one voxel among the plurality of voxels.

The changing the radiance information on each basis of the at least one voxel may include selecting a vertex based on a number of training pixels used to change radiance information on each basis of each candidate vertex among candidate vertices of voxels included in a training super-voxel; and changing radiance information on each basis of the selected vertex by using radiance information on each basis of the training super-voxel.

According to another aspect of an embodiment, there is provided a non-transitory computer-readable storage medium configured to store one or more instructions, in which the one or more instructions, when executed by a processor of an electronic device, cause the electronic device to perform a method including determining a target point by using a virtual ray projected toward a target pixel on an image plane among a plurality of pixels of a two-dimensional (2D) image from a viewpoint, based on obtaining the viewpoint in a three-dimensional (3D) space and information on the image plane; determining a target voxel including the target point among a plurality of voxels of the 3D space; determining an incident direction in which the virtual ray is incident on the target point, obtaining radiance information on each basis of the target voxel with respect to a plurality of bases; and determining a radiance of the target point corresponding to the incident direction by using the incident direction and the radiance information on each basis of the target voxel.

According to an aspect of an embodiment, there is provided an electronic device including at least one processor comprising a processing circuit and a memory including one or more storage media configured to store instructions, in which the instructions, when executed individually or collectively by the at least one processor, cause the electronic device to determine a target point by using a virtual ray projected toward a target pixel on an image plane among a plurality of pixels of a two-dimensional (2D) image from a viewpoint, based on obtaining the viewpoint in a three-dimensional (3D) space and information on the image plane; determine a target voxel comprising the target point among a plurality of voxels of the 3D space; determine an incident direction in which the virtual ray is incident on the target point, obtain radiance information on each basis of the target voxel with respect to a plurality of bases; and determine a radiance of the target point corresponding to the incident direction by using the incident direction and the radiance information on each basis of the target voxel.

The instructions, when executed individually or collectively by the at least one processor, may cause the electronic device to determine a color of the target pixel based on the radiance of the target point and obtain the 2D image corresponding to a scene of the 3D space, which is a result of projecting the virtual ray toward the image plane from the viewpoint, by determining a color of each of the plurality of pixels of the 2D image.

The obtaining the radiance information on each basis of the target voxel may include, as radiance information of each vertex of the target voxel, radiance feature coefficients indicating radiances of a vertex according to the plurality of bases.

The instructions, when executed individually or collectively by the at least one processor, may cause the electronic device to, based on scattering of the virtual ray projected toward the target pixel from the viewpoint, determine a point where the scattering of the virtual ray occurs to be the target point.

The instructions, when executed individually or collectively by the at least one processor, may cause the electronic device to determine a radiance of a vertex corresponding to the incident direction by using the incident direction and radiance information on each basis of the vertex with respect to a plurality of vertices of the target voxel; and based on a distance between a position of the target point in the target voxel and each vertex of the target voxel, obtain a result of interpolating radiances of the plurality of vertices as the radiance of the target point.

Additional aspects of embodiments will be set forth in part in the description which follows and, in part, will be apparent from the description, or may be learned by practice of the present disclosure.

### BRIEF DESCRIPTION OF THE DRAWINGS

The above and/or other aspects will be more apparent by describing certain embodiments with reference to the accompanying drawings, in which:

FIG. 1 is a diagram illustrating an operation of an electronic device obtaining a two-dimensional (2D) image for a scene in a three-dimensional (3D) space, according to various embodiments;

FIG. 2 is a diagram illustrating an operation of an electronic device obtaining a 2D image by using radiance information on each basis, according to various embodiments;

FIG. 3 is a diagram illustrating an operation of an electronic device determining a color of a target pixel when determining two or more points as target points, according to various embodiments;

FIG. 4 is a diagram illustrating an operation of an electronic device updating radiance information on each basis of at least one voxel or vertex in a 3D space, according to various embodiments;

FIG. 5 is a diagram illustrating an operation of an electronic device using training super-voxels to change radiance information on each basis, according to various embodiments; and

FIG. 6 is a block diagram illustrating an electronic device according to various embodiments.

### DETAILED DESCRIPTION

The following detailed structural or functional description is provided as an example only and various alterations and modifications may be made to the examples. Here, the embodiments are not construed as limited to the present disclosure and should be understood to include all changes, equivalents, and replacements within the idea and the technical scope of the present disclosure.

Terms, such as first, second, and the like, may be used herein to describe various components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

As used herein, the singular forms “a”, “an”, and “the” include the plural forms as well, unless the context clearly indicates otherwise. It will be further understood that the terms “comprises/including” and/or “includes/including” when used herein, specify the presence of stated features, integers, operations, operations, elements, and/or components, but do not preclude the presence or addition of one or more other features, integers, operations, operations, elements, components and/or groups thereof.

Unless otherwise defined, all terms, including technical and scientific terms, used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments are described in detail with reference to the accompanying drawings. When describing the embodiments with reference to the accompanying drawings, like reference numerals refer to like elements and a repeated description related thereto will be omitted.

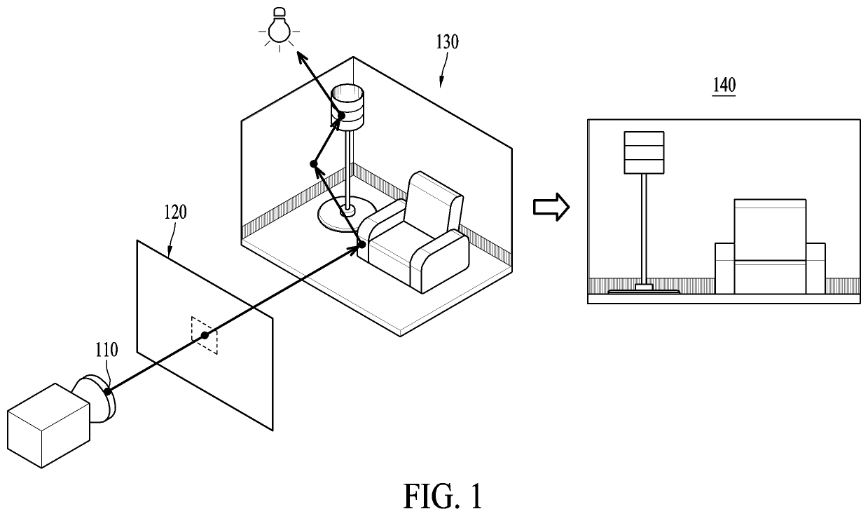

FIG. 1 is a diagram illustrating an operation of an electronic device obtaining a two-dimensional (2D) image for a scene in a three-dimensional (3D) space, according to various embodiments.

According to an embodiment, the electronic device may obtain a 2D image 140 for a scene in a 3D space 130.

The electronic device may obtain information on the 3D space 130. In various embodiments of the present disclosure, the 3D space 130 may include a virtual space (e.g., a game space or a metaverse space), but embodiments are not limited thereto and may include a real space. The information on the 3D space 130 may include information required to perform ray tracing. For example, the information on the 3D space 130 may include a bidirectional scattering distribution function (BSDF) of a point (or a surface) in the 3D space 130. The information on the 3D space 130 may include information (e.g., position information of an object, category information of the object, or color information of the object) on the object in the 3D space 130, information (e.g., position information of illumination) on a light source in the 3D space 130, and radiance information of the 3D space 130.

The electronic device may obtain information on the 2D image 140. In various embodiments of the present disclosure, the 2D image 140 may also be referred to as a frame. The information on the 2D image 140 may include a viewpoint 110 of a camera (or a virtual camera) capturing at least a portion of the 3D space 130 and information on an image plane 120. The 2D image 140 may include a result of casting (or projecting) light sensed from the viewpoint 110 onto the image plane 120 of light (or rays) emitted from the 3D space 130. According to an embodiment, the electronic device may obtain a plurality (e.g., a plurality of frames) of 2D images 140 for the 3D space 130. The plurality of frames may correspond respectively to different timepoints. For example, the electronic device may obtain a frame every predetermined time interval (e.g., 1 second). The viewpoint 110 of each frame and the image plane 120 of the frame may be independent of the viewpoint 110 of another frame and the image plane 120 of the another frame. For example, the viewpoint 110 of each frame and the image plane 120 of the frame may be the same as or different from the viewpoint 110 of another frame and the image plane 120 of the another frame. The information on the 3D space 130 may change over time. For example, between a first timepoint and a second timepoint, one of the information on the object in the 3D space 130, the information on the light source in the 3D space 130, and/or the information on the BSDF of the point (or the surface) in the 3D space may change. However, the information on the 3D space 130 is not limited to changing between the first timepoint and the second timepoint, and the information on the 3D space 130 may be maintained.

The electronic device, based on the result of casting a virtual ray onto each pixel of the 2D image 140, may determine a color value of the pixel. The casting of the virtual ray may be performed through ray tracing. In various embodiments of the present disclosure, ray tracing may include determining points where the virtual ray scatters (e.g., refracts, reflects, and/or penetrates) more than once (e.g., until reaching a light source or until scattering as many as a threshold number of times) in the 3D space 130.

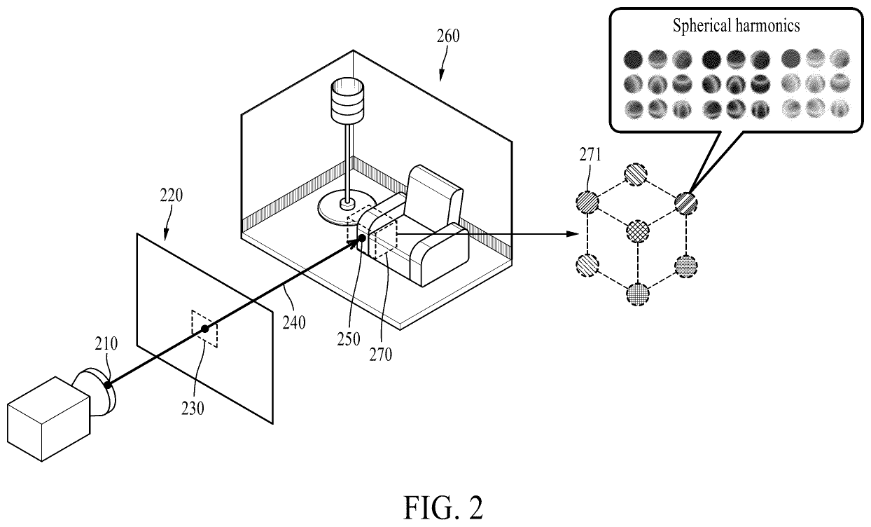

The electronic device, based on radiance of a point in the 3D space 130 where the virtual ray scatters, may determine the color of a pixel of the 2D image 140. As described below with reference to FIG. 2, the radiance of a point may be determined depending on a specific direction (e.g., corresponding to an incident direction of a virtual ray). The radiance of a point corresponding to the incident direction may include information on a color of light scattering (or emitted) in the incident direction (or an opposite direction to the incident direction) from the point.

For example, the radiance of the point corresponding to the incident direction may include an R value, a G value, and a B value. As described below with reference to FIGS. 2 to 5, the radiance of a point may vary depending on directions. According to an embodiment, the radiance of a point may include radiance feature coefficients respectively corresponding to one or more bases. The radiance of a point corresponding to a specific direction may be obtained as a result of processing radiance feature coefficients based on a result of applying a conversion algorithm of a spherical harmonics to the specific direction. An operation of obtaining the radiance of the point corresponding to the specific direction will be described later in more detail with reference to FIGS. 2 to 5.

FIG. 2 is a diagram illustrating an operation of an electronic device obtaining a 2D image by using radiance information on each basis, according to various embodiments.

According to an embodiment, the electronic device may determine a point in a 3D space corresponding to a specific pixel of a 2D image (e.g., the 2D image 140 of FIG. 1) and may determine the color of the specific pixel by using the radiance information of each basis of a voxel including the determined point. In various embodiments of the present disclosure, the pixel of which the color is to be determined by the electronic device may also be referred to as a “target pixel 230”, a point corresponding to the target pixel 230 may also be referred to as a “target point 250”, and a voxel including the target pixel 230 may also be referred to as a “target voxel 270”.

The electronic device may obtain information about a viewpoint 210 and an image plane 220. The information on the viewpoint 210 may include the position information of the viewpoint 210. For example, the position information of the viewpoint 210 may include a coordinate value according to a coordinate system (e.g., a world coordinate system) for a 3D space 260. The information on the image plane 220 may include size information and/or position information (or pose information) of the image plane 220. The electronic device may determine a color of a plurality of pixels of a 2D image determined based on the viewpoint 210 and the image plane 220. The operation of the electronic device determining the color of one pixel (e.g., the target pixel 230) of the plurality of pixels is described below.

The electronic device may determine the target point 250 of the 3D space 260, based on the obtaining of the information on the viewpoint 210 and the image plane 220 regarding the 3D space 260. The electronic device may determine the target point 250 by using a virtual ray 240 cast onto the target pixel 230 from the viewpoint 210. For example, the electronic device, based on the scattering of the virtual ray 240, may determine a point where the scattering of the virtual ray 240 has occurred to be the target point 250.

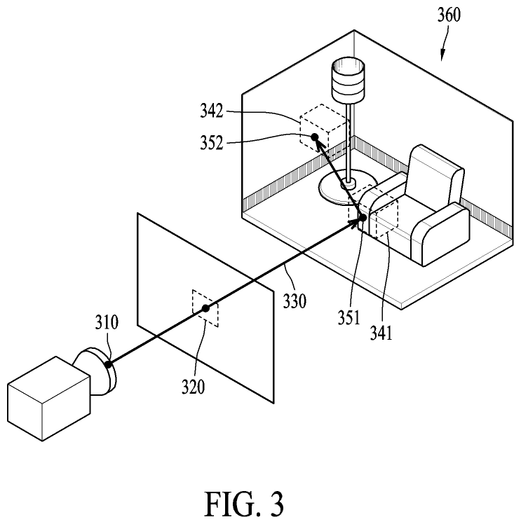

The electronic device may determine a voxel including the target point 250 among a plurality of voxels of the 3D space 260 to be the target voxel 270. The target voxel 270 may refer to a voxel corresponding to the target pixel 230 among the plurality of voxels of the 3D space 260. As described in more detail later with reference to FIG. 3, the target voxel 270 may be determined to be one voxel or a plurality of voxels.

The electronic device may determine an incident direction in which the virtual ray 240 strikes (or is incident on) the target point 250. For example, the electronic device, based on the target point 250 being a point where the scattering of the virtual ray 240 has occurred first, may determine a direction from the viewpoint 210 to the target point 250 to be the incident direction of the target point 250. Although not shown explicitly in FIG. 2, if a target point is a point where the scattering of the virtual ray 240 has occurred second, the determining of the incident direction is described in more detail later with reference to FIG. 3.

The electronic device may obtain radiance information on each basis of the target voxel 270 with respect to a plurality of bases of the target voxel 270. As described in more detail later, the radiance information of a target voxel or a vertex may include radiance feature coefficients (e.g., a red radiance feature coefficient, a green radiance feature coefficient, and a blue radiance feature coefficient) according to each basis. For example, a number of bases may be 9. However, according to various embodiments of the present disclosure, the number of the plurality of bases is not limited to 9, but the number of bases may be any number other than 9 (e.g., 3 or 27).

According to an embodiment, the radiance information on each basis of the target voxel 270 may include the radiance information on each basis of each vertex (e.g., a vertex 271) of the target voxel 270. For example, the target voxel 270 may have eight vertices. The radiance information on each basis of the target voxel 270 may include the radiance information of each of the eight vertices. The radiance information of each vertex may include radiance feature coefficients indicating radiance of a vertex according to the plurality of bases. For example, the radiance information of a vertex may include radiance feature coefficients (e.g., a red radiance feature coefficient, a green radiance feature coefficient, and a blue radiance feature coefficient) indicating radiance according to each of the plurality of bases.

The radiance information of a vertex may include radiance feature coefficients according to a plurality of bases of a color with respect to each of red, green, and blue colors. For example, if the number of bases is 9, the radiance information of a vertex may include nine red radiance feature coefficients according to the plurality of bases, nine green radiance feature coefficients according to the plurality of bases, and nine blue radiance feature coefficients according to the plurality of bases. In various embodiments of the present disclosure, radiance feature coefficients according to a specific basis of a specific vertex may also be referred to as a spherical harmonics' coefficients.

The electronic device may determine the radiance of the target point 250 corresponding to the incident direction by using the incident direction and the radiance information on each basis of the target voxel 270.

According to an embodiment, the electronic device may determine the radiance of a plurality of vertices corresponding to the incident direction and may determine the radiance of the target point 250 based on a result of combining (e.g., interpolating) the radiance of the plurality of vertices.

The electronic device may determine the radiance of a vertex corresponding to the incident direction by using the incident direction and radiance information on each basis of the vertex with respect to a plurality of vertices of the target voxel 270.

For example, the electronic device, based on the incident direction, may determine the radiance of the vertex corresponding to the incident direction. For example, the electronic device, based on a result of applying a conversion algorithm of a spherical harmonics to a scattering direction that is opposite to the incident direction, may obtain the radiance of the vertex corresponding to the incident direction. The radiance of a vertex corresponding to a specific direction (e.g., the incident direction) may include an R value, a G value, and a B value.

The electronic device may combine (e.g., interpolate) the radiance of the plurality of vertices corresponding to the incident direction based on the target point 250 of the virtual ray 240. The electronic device, based on a distance between the position of the target point 250 in the target voxel 270 and each vertex of the target voxel 270, may obtain a result of interpolating the radiance of the plurality of vertices as the radiance of the target point 250.

For example, the electronic device may determine the distance between each of the plurality of vertices and the target point 250. The electronic device may determine a weight for a vertex based on the distance between each vertex and the target point 250. The electronic device may determine a weight for a vertex to have a greater value as the distance between each vertex and the target point 250 is greater. For example, the electronic device may determine a first weight for a first vertex to have a greater value than a second weight for a second vertex based on a distance between the first vertex and the target point 250 that is greater than a distance between the second vertex and the target point 250. The electronic device may calculate (e.g., calculate a weighted average) the radiance of the plurality of vertices according to weights. The electronic device may determine the radiance of the target point 250, based on a result of calculating the radiance of the plurality of vertices according to the weights.

According to an embodiment, the electronic device may calculate the radiance of the target point 250 according to Equation 1 below:

$${R}_{point} = {\sum }_{v ∈ V} {w}_{v} ( {\sum }_{k ∈ K} {h}_{v , R , k} {SH}_{k} ( {d}_{x} , {d}_{y} , {d}_{z} ) ) {G}_{point} = {\sum }_{v ∈ V} {w}_{v} ( {\sum }_{k ∈ K} {h}_{v , G , k} {SH}_{k} ( {d}_{x} , {d}_{y} , {d}_{z} ) ) {B}_{point} = {\sum }_{v ∈ V} {w}_{v} ( {\sum }_{k ∈ K} {h}_{v , B , k} {SH}_{k} ( {d}_{x} , {d}_{y} , {d}_{z} ) ) \qquad [ Equation 1 ]$$

Here, Rₚₒᵢₙₜ denotes an R value of the radiance of the target point 250, Gₚₒᵢₙₜ denotes a G value of the radiance of the target point 250, and Bₚₒᵢₙₜ denotes a B value of the radiance of the target point 250. V denotes a set of vertices of the target voxel 270 and v denotes one of the vertices of the target voxel 270. wᵥ denotes a weight (e.g., an interpolation weight determined based on a distance between a vertex v and the target point 250) for the vertex v.

K denotes a set of bases, and k denotes one of the bases. h_{v, R, k} denotes a red radiance feature coefficient of a vertex v according to a basis k, h_{v, G, k} denotes a green radiance feature coefficient of the vertex v according to the basis k, and h_{v, B, k} denotes a blue radiance feature coefficient of the vertex v according to the basis k.

dₓ, d_{y}, and d_{z} denote an x-axis component, a y-axis component, and a z-axis component, respectively. SHₖ denotes a basis function of the basis k. For example, SHₖ(dₓ, d_{y}, d_{z}) denotes a result of applying an incident direction to (dₓ, d_{y}, d_{z}) the basis function SHₖ of the basis k. As shown in Equation 1, SHₖ(dₓ, d_{y}, d_{z}) may be used as a weight applied (e.g., multiplied) to a red radiance feature coefficient, a green radiance feature coefficient, and a blue radiance feature coefficient according to the basis k.

The electronic device may determine the color of the target pixel 230 based on the radiance of the target point 250. The color of the target pixel 230 may include an R value, a G value, and a B value.

For example, the electronic device may determine the radiance of the target point 250 to be a color of the target pixel 230, based on determining a point to be the target point 250.

For example, the electronic device may determine the color of the target pixel 230 based on a result of applying weights for target points to the radiance of the target points, based on determining two or more points to be the target points 250. The determining of the color of the target pixel 230 when determining the two or more points to be the target points 250 is described in more detail later with reference to FIG. 3.

According to an embodiment, the electronic device, as a result of processing each of the plurality of pixels of the 2D image as the target pixel 230, may determine the color of the plurality of pixels. For example, the electronic device may obtain the 2D image corresponding to a scene of the 3D space 260, which is cast (or projected) toward the image plane 220 from the viewpoint 210, by determining the color of each of the plurality of pixels of the 2D image.

FIG. 3 is a diagram illustrating an operation of an electronic device determining a color of a target pixel when determining two or more points as target points, according to various embodiments.

According to an embodiment, the electronic device may cast and/or trace a virtual ray 330 in a direction toward a target pixel 320 from a viewpoint 310. For example, the electronic device may determine a point where scattering of the virtual ray 330 occurs by using information (e.g., a BSDF) on a 3D space 360.

The electronic device may determine a first target point 351 based on the virtual ray 330 scattering at the first target point 351 in the 3D space 360. The electronic device may determine a first target voxel 341 including the first target point 351. The first target point 351 may be a point where the virtual ray 330 first scatters in the 3D space 360.

The electronic device may determine a second target point 352 based on the virtual ray 330 scattering at a second target point 352 in the 3D space 360 after scattering at the first target point 351. The electronic device may determine a second target voxel 342 including the second target point 352.

According to an embodiment, the electronic device may determine whether to continue tracing a path of the virtual ray 330 based on at least one parameter on the scattering at the first target point 351.

For example, the electronic device may continue tracing the path of the virtual ray 330 when the at least one parameter on the scattering at the first target point 351 is greater than or equal to a threshold value (e.g., when at least one of a reflection parameter of the first target point 351 or a refraction parameter of the first target point 351 is greater than or equal to the threshold value). The electronic device may determine the second target point 352 and/or the second target voxel 342 including the second target point 352 based on the continuing of the tracing of the path of the virtual ray 330. The electronic device may determine a direction (e.g., a refraction direction or a reflection direction) in which the virtual ray 330 is to be cast from the first target point 351 by using information (e.g., a BSDF) on the scattering at the first target point 351. The electronic device may determine the casting of the virtual ray 330 in a direction determined from the first target point 351.

For example, the electronic device may stop tracing the path of the virtual ray 330 when the parameters on the scattering at the first target point 351 are less than the threshold value (e.g., when both the reflection parameter of the first target point 351 and the refraction parameter of the first target point 351 is less than the threshold value). The electronic device may skip the determining of the second target point 352 and/or the second target voxel 342 based on the stopping (e.g., not continuing) of the tracing of the path of the virtual ray 330. In other words, the electronic device may determine the first target point 351 to be a target point and may complete the determining of the target point. The electronic device may determine the first target voxel 341 to be a target voxel and may complete the determining of the target voxel.

The electronic device, when determining two or more points to be the target points, may determine the radiance of each target point and may determine the color of the target pixel 320 based on weights for the target points.

According to an embodiment, the electronic device may determine first radiance of the first target point 351 corresponding to a direction (e.g., a first incident direction) from the target pixel 320 to the first target point 351, based on radiance information on each basis of the first target voxel 341.

For example, the electronic device may determine the first incident direction toward the first target point 351 from the viewpoint 310. The electronic device may determine the first radiance of the first target point 351 corresponding to the first incident direction, based on the radiance information on each basis of the first target voxel 341, the first incident direction, and the first target point 351. The electronic device may determine the first radiance of the first target point 351 in the same or similar manner as described above with reference to FIG. 2.

According to an embodiment, the electronic device may determine second radiance of the second target point 352 corresponding to a direction from the first target point 351 to the second target point 352, based on radiance information on each basis of the second target voxel. 342

For example, the electronic device may determine a second incident direction from the first target point 351 to the second target point 352. The electronic device may determine the second radiance of the second target point 352 corresponding to the second incident direction by using the radiance information on each basis of the second target voxel 342, the second incident direction, and the second target point 352. The electronic device may determine the second radiance of the second target point 352 in the same or similar manner as described above with reference to FIG. 2.

According to an embodiment, the electronic device may obtain adjusted second radiance of the second target point 352, which indicates radiance of a ray reaching the target pixel 320 through the first target point 351 from the second target point 352, based on the second radiance of the second target point 352 and a BSDF of the first target point 351.

For example, the electronic device may adjust the second radiance by applying (e.g., multiplying) a weight based on the BSDF of the first target point 351 to the second radiance of the second target point 352 corresponding to the second incident direction.

According to an embodiment, the electronic device may determine the color of the target pixel 320 based on the first radiance of the first target point 351 and the adjusted second radiance of the second target point 352.

For example, the electronic device may determine the color of the target pixel 320 based on Equation 2 below:

$$[ \begin{matrix}{R}_{pixel} \\ {G}_{pixel} \\ {B}_{pixel}\end{matrix} ] = [ \begin{matrix}{R}_{point 1} \\ {G}_{point 1} \\ {B}_{point 1}\end{matrix} ] + {w}_{point 2} [ \begin{matrix}{R}_{point 2} \\ {G}_{point 2} \\ {B}_{point 2}\end{matrix} ] \qquad [ Equation 2 ]$$

Here, Rₚᵢₓₑₗ, Gₚᵢₓₑₗ, and Bₚᵢₓₑₗ respectively denote an R value, a G value, and a B value of the color of the target pixel. Rₚₒᵢₙₜ₁, Gₚₒᵢₙₜ₁, and Bₚₒᵢₙₜ₁ respectively denote an R value, a G value, and a B value of the radiance of the first target point 351 corresponding to the first incident direction. Rₚₒᵢₙₜ₂, Gₚₒᵢₙₜ₂, and Bₚₒᵢₙₜ₂ respectively denote an R value, a G value, and a B value of the radiance of the first target point 351 corresponding to the first incident direction. wₚₒᵢₙₜ₂ denotes a weight based on the BSDF of the first target point 351. wₚₒᵢₙₜ₂ denotes the adjusted second radiance of the second target point 352 by using the weight.

Although FIG. 3 mainly illustrates two or more points being determined to be the target points, three or more points may be determined to be the target points according to various embodiments of the present disclosure. The electronic device may determine an incident direction in which the virtual ray 330 strikes (or is incident on) each target point. The electronic device may determine the radiance of each target point corresponding to the incident direction. The electronic device may determine a weight corresponding to each target point, based on a BSDF of a previous target point. The previous target point refers to a target point where the scattering of the virtual ray 330 has occurred prior to each target point. The electronic device may determine the color of the target pixel, based on the result of applying a weight corresponding to each target point to the radiance of the target point.

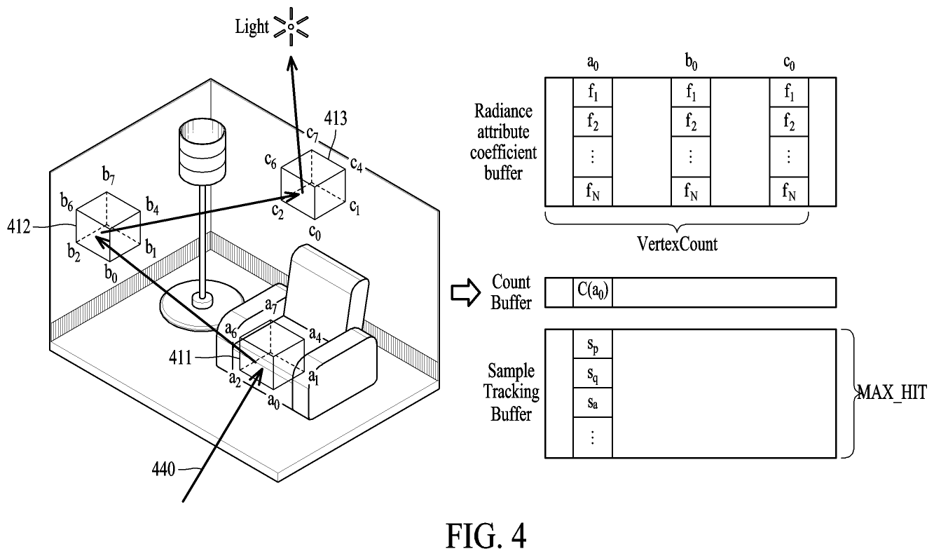

FIG. 4 is a diagram illustrating an operation of an electronic device updating radiance information on each basis of at least one voxel or vertex in a 3D space, according to various embodiments.

According to an embodiment, the electronic device may change (e.g., update) the radiance information on each basis of at least one voxel or vertex in the 3D space, based on a difference between a ground-truth color of a target pixel and a temporary color of the target pixel. In various embodiments of the present disclosure, changing of the radiance information on each basis of a voxel or a vertex may also be referred to as training or learning the radiance information on each basis of a voxel or a vertex.

According to an embodiment, the electronic device, when obtaining information on a viewpoint or an image plane, may train the radiance information on each basis of a voxel or a vertex by using at least one pixel among a plurality of pixels of a 2D image. In various embodiments of the present disclosure, a pixel used to train the radiance information on each basis may be referred to as a “training pixel” or a voxel corresponding to the training pixel among a plurality of voxels in the 3D space may be referred to as a “training voxel”.

The electronic device may obtain the training pixel among the plurality of pixels of the 2D image, based on the obtaining of the viewpoint and the information on the image plane. For example, the electronic device may select (e.g., randomly select) a predetermined number of training pixels among the plurality of pixels.

The electronic device may determine one or more training voxels including at least one point where a training virtual ray cast (or projected) toward the training pixel from the viewpoint scatters in the 3D space. The electronic device may trace the training virtual ray until satisfying a preset condition (e.g., the training virtual ray reaching a light source and/or a cumulative number of refraction and/or reflection of the training virtual ray is a threshold number). The electronic device may determine voxel(s) including point(s) where the scattering of the training virtual ray has occurred to be training voxels corresponding to the training pixels while tracing the training virtual ray.

Referring to FIG. 4, an electronic device may obtain a first voxel 411 including vertices a₀ to a₇, a second voxel 412 including vertices b₀ to b₇, and a third voxel 413 including vertices c₀ to c₇, as training voxels based on the training virtual ray 440. For example, the electronic device may determine one or more training voxels 411-413 through ray tracing and/or path tracing.

The electronic device may determine a temporary color of a training pixel based on radiance information on each basis of the one or more training voxels 411-413. In the same or similar manner as described above regarding the obtaining of the color of the target pixel based on the radiance of one target point or the radiance of two or more target points with reference to FIGS. 1 to 3, the electronic device, with respect to each of the training points where the scattering of the training virtual ray 440 has occurred, may obtain the radiance of a training point corresponding to an incident direction in which the training virtual ray 440 strikes (or is incident on) the training point. The electronic device may determine the temporary color of the training pixel based on the radiance of training points.

The electronic device may obtain a ground-truth color of the training pixel. According to an embodiment, the electronic device may calculate the ground-truth color of the training pixel based on path tracing. According to an embodiment, the electronic device may load the ground-truth color of the training pixel from an internal memory.

The electronic device may determine a variance in the radiance information on each basis of the one or more training voxels 411-413 based on a difference between the temporary color of the training pixel and the ground-truth color of the training pixel. For example, the electronic device may determine a variance in the radiance information on each basis of a specific training voxel, based on a gradient of the difference between the temporary color of the training pixel and the ground-truth color of the training pixel with respect to the radiance information on each basis of the specific training voxel.

According to an embodiment, the electronic device may collect a training data set for each vertex of a training voxel by using the plurality of training pixels and may determine a variance in radiance information on each basis of a corresponding vertex by using the training data set for each vertex.

For example, the electronic device, in response to determining a training voxel, may add the training pixel to a training data set of vertices of the training voxel. According to an embodiment, the electronic device may manage a radiance feature coefficient buffer corresponding to a plurality of vertices, a count buffer, and a sample tracking buffer. The radiance feature coefficient buffer may store radiance information on each basis of a vertex. For example, the radiance feature coefficient buffer corresponding to one vertex may store three-color radiance feature coefficients (e.g., 27 spherical harmonics coefficients) according to nine bases. The count buffer may store the number of pixels (e.g., training pixels) collected as a training data set of a vertex. The sample tracking buffer may store information (e.g., identification information of a training pixel) on a pixel collected as a training data set of a vertex. The electronic device may further store a number (expressed by “VertexCount” in FIG. 4) of vertices storing radiance information on each basis.

The electronic device, based on determining a training voxel corresponding to a training pixel, may increase (e.g., increase by 1) the value stored in a count buffer of each of vertices of the training voxel. The electronic device, based on the determining of the training voxel corresponding to the training pixel, may add (e.g., insert) information (e.g., the identification information of the training pixel) about the training pixel to a sample tracking buffer of each of the vertices of the training voxel. The electronic device, as a result of determining of training voxel(s) with respect to each of the plurality of training pixels, may collect a training data set for vertices of at least one voxel in a 3D space.

According to an embodiment, the electronic device may manage a limitation (expressed by “MAX_HIT” in FIG. 4) on a number of training pixels collectable as a training data set of each vertex. For example, the electronic device, in response to the determining of the training voxel, may compare a number (e.g., a value stored in a count buffer corresponding to a specific vertex) of other training pixels included in a training data set of the specific vertex of the training voxel with a threshold number. The electronic device, based on the number (e.g., a value stored in the count buffer corresponding to the specific vertex) of other training pixels included in the training data set of the specific vertex of the training voxel being greater than or equal to a threshold number, may skip the adding of the training pixel to the training data set of specific vertex of the training voxel. The electronic device, based on the number of other training pixels included in the training data set of the specific vertex of the training voxel being less than the threshold number, may add the training pixel to the training data set of the specific vertex.

According to an embodiment, the electronic device, by limiting a number of training pixels collectable as a training data set of each vertex, may reduce uncertainty in training (or learning) radiance information on each basis of a voxel or a vertex and may prevent an excessive increase of throughput.

The electronic device may determine a variance in radiance information on each basis based on a training data set of a vertex with respect to each vertex. The electronic device, with respect to each vertex, based on the determined variance in the radiance information on each basis of the vertex, may change (e.g., update or train) the radiance information on each basis of the vertex.

For example, the electronic device may change the radiance information on each basis of the vertex based on Equation 3 below:

$$Δ {f}_{i} = {\sum }_{{s}_{k} ∈ S} {w}_{k} Δ {s}_{k , i} \qquad [ Equation 3 ]$$

Here, fᵢ denotes a value (e.g., a red radiance feature coefficient according to a first basis) of one color according to a specific basis of the radiance information on each basis of the vertex, and Δfᵢ denotes a variance of fᵢ. S denotes the training data set of the vertex, and sₖ denotes a training pixel included in the training data set of the vertex. Δs_{k,i} denotes a gradient of a difference between a temporary color and a ground-truth color of a training pixel sₖ for fᵢ. wₖ denotes a weight of the training pixel sₖ.

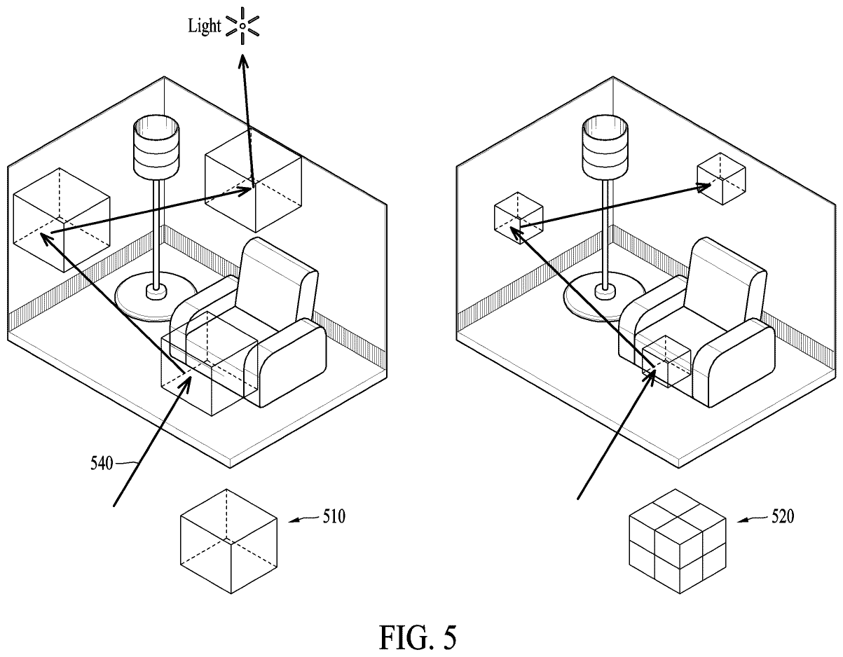

FIG. 5 is a diagram illustrating an operation of an electronic device using training super-voxels to change radiance information on each basis, according to various embodiments.

According to an embodiment, the electronic device may divide a 3D space into a plurality of super-voxels having a greater size than a voxel size. Referring to FIG. 5, for example, a width, a length, and a height of one super-voxel 510 may double a width, a length, and a height of one voxel. In other words, one super-voxel 510 may cover a space of eight voxels 520.

The electronic device may determine one or more training super-voxels including at least one point where a training virtual ray 540 scatters. The electronic device, based on a temporary color of a training pixel and a ground-truth color of the training pixel, may change radiance on each basis of the one or more training super-voxels. In the same or similar manner as described above with reference to FIG. 4, the electronic device may change radiance information on each basis of a vertex of a training super-voxel by processing the training super-voxel in the same or similar manner of processing a training voxel.

The electronic device, based on the changed radiance information on each basis of the one or more training super-voxels, may change radiance information on each basis of at least one voxel among a plurality of voxels.

According to an embodiment, the electronic device may select a vertex based on a number of training pixels used to change radiance information on each basis of each candidate vertex among candidate vertices of voxels included in a training super-voxel. For example, the electronic device may select a candidate vertex as a vertex based on a number of training pixels used to change (e.g., train) radiance information on each basis of the candidate vertex being less than or equal to a threshold number.

The electronic device may change radiance information on each basis of the selected vertex, based on radiance information on each basis of the training super-voxel.

For example, the electronic device may interpolate (e.g., interpolate based on a distance between a vertex of the training super-voxel and a position of the selected vertex) radiance information on each basis of vertices of the training super-voxel, based on the position of the selected vertex in the training super-voxel. For example, the electronic device may replace (e.g., initialize) a result of the interpolation with the radiance information on each basis of the selected vertex. For example, the electronic device may change the radiance information on each basis of the selected vertex to a value combining (e.g., weighted averaging) the result of the interpolation and the radiance information on each basis of the selected vertex according to weights.

According to an embodiment, the electronic device may perform coarse training on radiance information on each basis of a vertex by using super-voxels. The electronic device, after performing the coarse training, may select a vertex lacking a number of training pixels (e.g., the number of training pixels is less than or equal to a threshold number) used for the training among vertices of voxels. The electronic device may change the radiance information on each basis of the selected vertex by using the result of the coarse training and may perform fine-training on the changed radiance information on each basis of the selected vertex. The electronic device, through coarse training and fine training, may obtain more accurate radiance information on each basis of a vertex of a voxel compared to training using a random initial value.

Although the electronic device using a single radiance model including radiance information on each basis of vertices of a plurality of voxels in a 3D space is mainly described in various embodiments of the present disclosure, embodiments are not limited thereto. The radiance model may refer to a model including radiance information on each basis of vertices of voxels in a 3D space. According to an embodiment, the electronic device may determine the radiance of a target point by using a plurality of radiance models corresponding to a radiance range.

According to an embodiment, the electronic device may use a first radiance model corresponding to a first radiance range and a second radiance model corresponding to a second radiance range. The first radiance range may not overlap or at least partially overlap with the second radiance range.

For example, the first radiance range may be greater than or equal to 0 and less than or equal to a threshold value (e.g., a value), and a second radiance range may be greater than or equal to a and less than or equal to maximum radiance. The electronic device may determine the radiance of the target point based on first partial radiance predicted by using the first radiance model and second partial radiance predicted by using the second radiance model.

For example, the radiance of the target point may be divided (e.g., segmented) into the first partial radiance and the second partial radiance based on Equation 4 below:

$${c}_{p , l} = mod ( {c}_{p} , a ) / {s}_{l} {c}_{p , h} = ( {c}_{p} - {s}_{l} {c}_{p , l} ) / {s}_{h} \qquad [ Equation 4 ]$$

Here, cₚ denotes radiance of a target point p corresponding to an incident direction dₓ, d_{y}, d_{z}. a denotes the threshold value for dividing the first radiance range and the second radiance range. c_{p,l} denotes a low component (e.g., a component corresponding to the first radiance range) and may refer to the first partial radiance of the target point p, estimated from the first radiance model. c_{p,h} denotes a high component (e.g., a component corresponding to the second radiance range) and may refer to the second partial radiance of the target point p, estimated from the second radiance model. s₁ and sₕ denote scale parameters for adjusting the first radiance range and the second radiance range to the same size.

For example, the electronic device may determine the radiance of the target point (e.g., a point at a position x, y, z) corresponding to the incident direction dₓ, d_{y}, d_{z} by using the first partial radiance and the second partial radiance based on Equation 5 below:

$${c}_{p , predict} ( x , y , z , {d}_{x} , {d}_{y} , {d}_{z} ) = {s}_{h} {c}_{p , h} ( x , y , z , {d}_{x} , {d}_{y} , {d}_{z} ) + {s}_{l} {c}_{p , l} ( x , y , z , {d}_{x} , {d}_{y} , {d}_{z} ) {c}_{p , l} ( x , y , z , {d}_{x} , {d}_{y} , {d}_{z} ) = {\sum }_{v ∈ V} {w}_{v} \times {c}_{v , l} ( {d}_{x} , {d}_{y} , {d}_{z} ) {c}_{p , h} ( x , y , z , {d}_{x} , {d}_{y} , {d}_{z} ) = {\sum }_{v ∈ V} {w}_{v} \times {c}_{v , h} ( {d}_{x} , {d}_{y} , {d}_{z} ) \qquad [ Equation 5 ]$$

Here, c_{p,predict} (x, y, z, dₓ, d_{y}, d_{z}) denotes the radiance of the target point of the position x, y, z corresponding to the incident direction dₓ, d_{y}, d_{z} and may refer to radiance predicted by using the first partial radiance and the second partial radiance. c_{p,l}(x, y, z, dₓ, d_{y}, d_{z}) denotes the first partial radiance of the target point of the position x, y, z corresponding to the incident direction dₓ, d_{y}, d_{z} and may refer to a low component of the radiance of the target point obtained by using the first radiance model. c_{p,h}(x, y, z, dₓ, d_{y}, d_{z}) denotes the second partial radiance of the target point of the position x, y, z corresponding to the incident direction dₓ, d_{y}, d_{z} and may refer to a high component of the radiance of the target point obtained by using the second radiance model. In the same or similar manner as shown in Equation 4, sₗ and sₕ denote scale parameters for adjusting the first radiance range and the second radiance range to the same size.

V denotes a set of vertices of a voxel including the target point of the position x, y, z, and v denotes one vertex of the voxel. wᵥ denotes an interpolation weight determined based on a distance between a vertex v and the target point of the position x, y, z. c_{v,l}(dₓ, d_{y}, d_{z}) denotes the first partial radiance of the vertex v corresponding to the incident direction dₓ, d_{y}, d_{z} based on the first radiance model, and c_{v,h}(dₓ, d_{y}, d_{z}) denotes the second partial radiance of the vertex v corresponding to the incident direction dₓ, d_{y}, d_{z} based on the second radiance model.

For example, the first radiance range may be greater than or equal to 0 and less than or equal to a first threshold value, and the second radiance range may be greater than or equal to 0 and less than or equal to a second threshold value. The first threshold value may be less than the second threshold value. The electronic device may determine the radiance of the target point based on the first radiance predicted by using the first radiance model and the second radiance predicted by using the second radiance model.

For example, the radiance of the target point may be divided (e.g., segmented) into the first partial radiance and the second partial radiance based on Equation 6 below:

$${c}_{p , h} = clip ( {c}_{p} , 0 , {h}_{max} ) / {h}_{max} {c}_{p , l} = clip ( {c}_{p} , 0 , {l}_{max} ) / {l}_{max} \qquad [ Equation 6 ]$$

Here, cₚ denotes the radiance of a target point p, lₘₐₓ denotes a first threshold value (e.g., an upper limit of the first radiance range), and hₘₐₓ denotes a second threshold value (e.g., an upper limit of the second radiance range). c_{p,l} denotes a low component (e.g., a component corresponding to the first radiance range) of cₚ, and c_{p,h} denotes a high component (e.g., a component corresponding to the second radiance range) of cₚ.

For example, the electronic device may determine the radiance of the target point (e.g., a point at the position x, y, z) corresponding to the incident direction dₓ, d_{y}, d_{z} by using the first partial radiance and the second partial radiance based on Equation 7.

$${c}_{p , predict} ( x , y , z , {d}_{x} , {d}_{y} , {d}_{z} ) = \{ \begin{matrix}{l}_{max} \times {c}_{p , l} ( x , y , z , {d}_{x} , {d}_{y} , {d}_{z} ) & {c}_{p , l} {l}_{max} < t \\ {h}_{max} \times {c}_{p , h} ( x , y , z , {d}_{x} , {d}_{y} , {d}_{z} ) & {c}_{p , l} {l}_{max} > t\end{matrix} \qquad [ Equation 7 ]$$

Here, c_{p,predict}(x, y, z, dₓ, d_{y}, d_{z}) denotes the radiance of the target point p corresponding to the incident direction dₓ, d_{y}, d_{z} and may refer to first partial radiance c_{p,h} (x, y, z, dₓ, d_{y}, d_{z}) of the target point corresponding to the incident direction dₓ, d_{y}, d_{z} and radiance predicted based on the first partial radiance c_{p,h}(x, y, z, dₓ, d_{y}, d_{z}) of the target point corresponding to the incident direction dₓ, d_{y}, d_{z}. c_{p,l}(x, y, z, dₓ, d_{y}, d_{z}) denotes the first partial radiance of the target point of the position x, y, z corresponding to the incident direction dₓ, d_{y}, d_{z} and may refer to a low component of the radiance of the target point obtained by using the first radiance model.

In the same or similar manner as shown in Equation 5, c_{p,h}(x, y, z, dₓ, d_{y}, d_{z}) is the second partial radiance of the target point of the position x, y, z of the incident direction dₓ, d_{y}, d_{z} and may refer to a high component of the radiance of the target point obtained by using the second radiance model. Although not explicitly shown in Equation 7, in the same or similar manner as described with reference to Equation 5, the first partial radiance and the second partial radiance may be calculated by using the radiance of vertices of a voxel including the target point, based on the first radiance model and the second radiance model, respectively. t denotes a threshold value to select one of the high component or the low component in the prediction.

According to an embodiment, the electronic device may obtain the radiance of the target point based on a radiance output model built for each voxel. The radiance output model may refer to a model generated and/or trained to output a piece of output data corresponding to the radiance of a target point corresponding to an incident direction from input data corresponding to the position of the target point and the incident direction.

The input data of the radiance output model may further include an auxiliary input of the target point. For example, the auxiliary input may include information on at least one of normal, diffuse reflectance, specular reflectance, and/or roughness. The radiance output model may be implemented based on a neural network.

The electronic device may train the radiance output model corresponding to a training voxel based on a training pixel, a training point, and/or the training voxel. The electronic device, with respect to a target pixel, may obtain the position information of a target point where the scattering of a virtual ray has occurred, and input data based on the incident direction in which the virtual ray strikes the target point. The electronic device may obtain the radiance of the target point corresponding to the incident direction by applying the radiance output model corresponding to the target voxel to the input data.

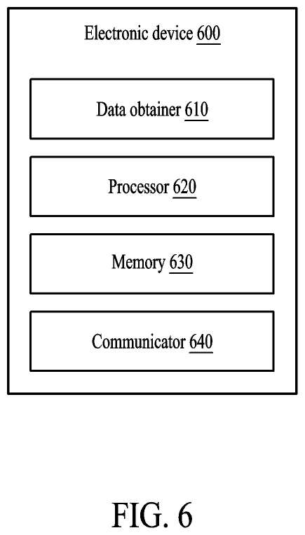

FIG. 6 is a block diagram illustrating an electronic device according to various embodiments.

According to an embodiment, an electronic device 600 may include a data obtainer 610, a processor 620, a memory 630, and a communicator 640.

The data obtainer 610 may obtain information on a viewpoint and an image plane and/or radiance information on each basis of a target voxel.

The processor 620 may obtain the information on the viewpoint and the image plane from the data obtainer 610. The processor 620 may determine a target point corresponding to the target pixel based on the information on the viewpoint and the image plane. The processor 620 may determine a target voxel including the target point. The processor 620 may determine an incident direction in which a virtual ray strikes (or is incident on) the target point. The processor 620 may obtain the radiance information on each basis of the target voxel. The processor 620 may determine the radiance of the target point corresponding to the incident direction of the virtual ray. According to an embodiment, the processor 620 may include at least one processor including a processor circuit. According to an embodiment, the processor 620 may include a central processing unit (CPU), a microprocessor, or the like.

The memory 630 may temporarily and/or permanently store at least one of the viewpoint, the image plane, the target pixel, the target point, the target voxel, the incident direction, the radiance information on each basis of the target voxel, or the radiance of the target point corresponding to the incident direction. The memory 630 may store instructions for determining the target point, determining the target voxel, determining the incident direction, obtaining the radiance information on each basis of the target voxel, and/or determining the radiance of the target point corresponding to the incident direction. When executed by the processor 620, the instructions may cause the electronic device 600 to perform the operations instructed by the instructions. However, the foregoing examples are just examples, and the information stored in the memory 630 is not limited thereto.

The communicator 640 may transmit or receive at least one of the viewpoint, the image plane, the target pixel, the target point, the target voxel, the incident direction, the radiance information on each basis of the target voxel, or the radiance of the target point corresponding to the incident direction. The communicator 640 may establish a wired communication channel and/or a wireless communication channel with the external device (e.g., the electronic device and the server) and may establish communication with the external device via a long-range communication network, such as cellular communication, short-range wireless communication, local area network (LAN) communication, Bluetooth™, Wi-Fi direct or infrared data association (IrDA), a legacy cellular network, a fourth generation (4G) and/or 5G network, next-generation communication, the Internet, or a computer network (e.g., LAN or a wide area network (WAN)).

Although not explicitly shown in FIG. 6, the electronic device 600 may include a display (not shown). The display may display the 2D image based on the color of the target pixel.

The examples described herein may be implemented by using a hardware component, a software component, and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing unit also may access, store, manipulate, process, and generate data in response to execution of the software. For purpose of simplicity, the description of a processing unit is used as singular; however, one skilled in the art would understand that a processing unit may include multiple processing elements and multiple types of processing elements. For example, the processing unit may include a plurality of processors, or a single processor and a single controller. In addition, different processing configurations are possible, such as parallel processors.

The software may include a computer program, a piece of code, an instruction, or some combination thereof, to independently or uniformly command or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random-access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may act as one or more software modules in order to perform the operations of the above-described examples, or vice versa.

As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof.

As described above, although the examples have been described with reference to the drawings, a person skilled in the art would understand that various technical modifications and variations can be made based thereon. Suitable results may be achieved if the described techniques are performed in a different order, and/or if components in a described system, architecture, device, or circuit are combined in a different manner, and/or replaced or supplemented by other components or their equivalents.

Accordingly, other implementations are within the scope of the following claims.

What is claimed is:

1. A method performed by an electronic device, the method comprising:
determining a target point by using a virtual ray that is projected toward a target pixel on an image plane among a plurality of pixels of a two-dimensional (2D) image from a viewpoint, based on obtaining the viewpoint in a two-dimensional (3D) space and information on the image plane;
determining a target voxel comprising the target point among a plurality of voxels of the 3D space;
determining an incident direction in which the virtual ray is incident on the target point;
obtaining radiance information on each basis of the target voxel with respect to a plurality of bases; and
determining a radiance of the target point corresponding to the incident direction by using the incident direction and the radiance information on each basis of the target voxel.

2. The method of claim 1, further comprising:
determining a color of the target pixel based on the radiance of the target point; and
obtaining the 2D image corresponding to a scene of the 3D space, which is a result of projecting the virtual ray toward the image plane from the viewpoint, by determining a color of each of the plurality of pixels of the 2D image.

3. The method of claim 1, wherein obtaining the radiance information comprises:
obtaining, as radiance information of each vertex of the target voxel, radiance feature coefficients indicating radiances of a vertex according to the plurality of bases.

4. The method of claim 1, wherein the determining the target point comprises:
determining a point where a scattering of the virtual ray occurs as the target point.

5. The method of claim 1, wherein the determining the radiance of the target point comprises:
determining a radiance of a vertex corresponding to the incident direction by using the incident direction and radiance information on each basis of the vertex with respect to a plurality of vertices of the target voxel; and
based on a distance between a position of the target point in the target voxel and each vertex of the target voxel, obtaining a result of interpolating radiances of the plurality of vertices as the radiance of the target point.

6. The method of claim 1, wherein the determining the target point comprises:
determining a first target point based on a scattering of the virtual ray at the first target point in the 3D space; and
determining a second target point based on a scattering at the second target point in the 3D space after the virtual ray scatters at the first target point, and
wherein the determining the target voxel comprises:
determining a first target voxel comprising the first target point; and
determining a second target voxel comprising the second target point.

7. The method of claim 6, wherein the determining the target voxel further comprises:
determining whether to continue tracing a path of the virtual ray based on at least one parameter on the scattering at the first target point,
wherein the determining of the second target point comprises:
determining the second target point based on continuing of the tracing of the path of the virtual ray, and
wherein the determining of the second target voxel comprises:
determining the second target voxel comprising the second target point based on the continuing of the tracing of the path of the virtual ray.

8. The method of claim 6, wherein the determining the radiance of the target point comprises:
determining a first radiance of the first target point corresponding to a direction from the target pixel to the first target point, based on radiance information on each basis of the first target voxel;
determining a second radiance of the second target point corresponding to a direction from the first target point to the second target point, based on radiance information on each basis of the second target voxel; and
obtaining an adjusted second radiance of the second target point, which indicates a radiance of a ray reaching the target pixel from the second target point through the first target point, based on the second radiance of the second target point and a bidirectional scattering distribution function (BSDF) of the first target point, and
wherein the method further comprises:
determining a color of the target pixel based on the first radiance of the first target point and the adjusted second radiance of the second target point.

9. The method of claim 8, wherein the determining the incident direction comprises:
determining a first incident direction toward the first target point from the viewpoint; and
determining a second incident direction toward the second target point from the first target point,
wherein the determining the first radiance of the first target point comprises:
determining the first radiance of the first target point corresponding to the first incident direction, based on the radiance information on each basis of the first target voxel, the first incident direction, and the first target point,
wherein the determining the second radiance of the second target point comprises:
determining the second radiance of the second target point corresponding to the second incident direction by using the radiance information on each basis of the second target voxel, the second incident direction, and the second target point, and
wherein the obtaining the adjusted second radiance comprises:
adjusting the second radiance by applying a weight based on the BSDF of the first target point to the second radiance of the second target point corresponding to the second incident direction.

10. The method of claim 1, further comprising:
obtaining a training pixel among the plurality of pixels of the 2D image, based on the obtaining of the viewpoint and the information on the image plane;
determining one or more training voxels comprising at least one point where a training virtual ray projected toward the training pixel from the viewpoint scatters in the 3D space,
determining a temporary color of the training pixel based on radiance information on each basis of the one or more training voxels;
obtaining a ground-truth color of the training pixel; and
determining a variance in the radiance information on each basis of the one or more training voxels based on a difference between the temporary color of the training pixel and the ground-truth color of the training pixel.

11. The method of claim 10, wherein the determining the one or more training voxels comprises:
based on determining a training voxel, adding the training pixel to a training data set of vertices of the training voxel,
wherein the determining the variance comprises:
determining a variance in radiance information on each basis of a vertex based on a training data set of the vertex, with respect to each vertex, and
wherein the method further comprises:
with respect to each vertex, based on the determined variance in the radiance information on each basis of the vertex, changing the radiance information on each basis of the vertex.

12. The method of claim 11, wherein the adding the training pixel comprises:
based on determining the training voxel, comparing a number of other training pixels comprised in the training data set of a vertex of the training voxel with a threshold number;
based on the number of other training pixels comprised in the training data set of the vertex of the training voxel being greater than or equal to the threshold number, skipping the adding of the training pixel to the training data set of the vertex; and
based on the number of other training pixels comprised in the training data set of the vertex of the training voxel being less than the threshold number, adding the training pixel to the training data set of the vertex.

13. The method of claim 10, further comprising:
dividing the 3D space into a plurality of super-voxels having a greater size than a voxel size;
determining one or more training super-voxels comprising at least one point where the training virtual ray scatters;
based on the temporary color of the training pixel and the ground-truth color of the training pixel, changing radiance information on each basis of the one or more training super-voxels; and
based on the changed radiance information on each basis of the one or more training super-voxels, changing radiance information on each basis of at least one voxel among the plurality of voxels.

14. The method of claim 13, wherein the changing the radiance information comprises:
selecting a vertex based on a number of training pixels used to change radiance information on each basis of each candidate vertex among candidate vertices of voxels comprised in a training super-voxel; and
changing radiance information on each basis of the selected vertex by using radiance information on each basis of the training super-voxel.

15. A non-transitory computer-readable storage medium configured to store one or more instructions,
wherein the one or more instructions, when executed by a processor of an electronic device, cause the electronic device to perform:
determining a target point by using a virtual ray projected toward a target pixel on an image plane among a plurality of pixels of a two-dimensional (2D) image from a viewpoint, based on obtaining the viewpoint in a three-dimensional (3D) space and information on the image plane;
determining a target voxel comprising the target point among a plurality of voxels of the 3D space;
determining an incident direction in which the virtual ray is incident on the target point;
obtaining radiance information on each basis of the target voxel with respect to a plurality of bases; and
determining a radiance of the target point corresponding to the incident direction by using the incident direction and the radiance information on each basis of the target voxel.

16. An electronic device comprising:
at least one processor comprising a processing circuit; and
a memory storing instructions,
wherein the instructions, when executed individually or collectively by the at least one processor, cause the electronic device to:
determine a target point by using a virtual ray that is projected toward a target pixel on an image plane among a plurality of pixels of a two-dimensional (2D) image from a viewpoint, based on obtaining the viewpoint in a three-dimensional (3D) space and information on the image plane;
determine a target voxel comprising the target point among a plurality of voxels of the 3D space;
determine an incident direction in which the virtual ray is incident on the target point;
obtain radiance information on each basis of the target voxel with respect to a plurality of bases; and
determine a radiance of the target point corresponding to the incident direction by using the incident direction and the radiance information on each basis of the target voxel.

17. The electronic device of claim 16, wherein the instructions, when executed individually or collectively by the at least one processor, cause the electronic device to:
determine a color of the target pixel based on the radiance of the target point, and
obtain the 2D image corresponding to a scene of the 3D space, which is a result of projecting the virtual ray toward the image plane from the viewpoint, by determining a color of each of the plurality of pixels of the 2D image.

18. The electronic device of claim 16, wherein the radiance information on each basis of the target voxel comprises:
as radiance information of each vertex of the target voxel, radiance feature coefficients indicating radiances of a vertex according to the plurality of bases.

19. The electronic device of claim 16, wherein the instructions, when executed individually or collectively by the at least one processor, cause the electronic device to,
based on scattering of the virtual ray projected toward the target pixel from the viewpoint, determine a point where the scattering of the virtual ray occurs to be the target point.

20. The electronic device of claim 19, wherein the instructions, when executed individually or collectively by the at least one processor, cause the electronic device to:
determine a radiance of a vertex corresponding to the incident direction by using the incident direction and radiance information on each basis of the vertex with respect to a plurality of vertices of the target voxel; and
based on a distance between a position of the target point in the target voxel and each vertex of the target voxel, obtain a result of interpolating radiances of the plurality of vertices as the radiance of the target point.
